(19) United States
(12) Patent Application Publication
(10) Pub. No.: US 2007/0215056 A1
(43) Pub. Date: Sep. 20, 2007

(54) WATERING SYSTEM FOR TURKEYS

(76) Inventors: LIONEL L. KREGER, WARSAW, IN (US); PHILIP C. WILFONG, GOSHEN, IN (US); ROGER S. KIPHART, WARSAW, IN (US); TIMOTHY W. MOMONT, GREEN FORREST, AR (US); LAVONE LEVI MILLER, MILFORD, IN (US); THEODORE J. COLE, MILFORD, IN (US); JAMES RICHARD KRAFT, NEW PARIS, IN (US); CHRISTOPHER RICHARD ROES, WARSAW, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/686,538

(22) Filed: Mar. 15, 2007

Related U.S. Application Data
(60) Provisional application No. 60/783,161, filed on Mar. 16, 2006.
(60) Provisional application No. 60/787,041, filed on Mar. 29, 2006.
(60) Provisional application No. 60/867,326, filed on Nov. 27, 2006.

(51) Int. Cl. A01K 7/00

(52) U.S. Cl. 119/72.5

(57) ABSTRACT

A watering system for turkeys includes a channel assembly and a pipe assembly covered and supported by the channel assembly. A hangar is wrapped around the channel assembly and the pipe assembly and is secured to itself above the channel assembly. The hangar is secured to an assembly for raising of lowering the watering system. The hangar is also wrapped and secured around a previously installed anti-roost wire. Nipple assemblies are connected to the pipe assembly and provide the turkeys with access to the water within the pipe assembly when the birds trigger the nipple assemblies. Catch cup assemblies are secured to the channel assembly and have first and second catch basins. The first catch basin is provided below one of the nipple assemblies and the second catch basin is provided below an adjacent nipple assembly. The catch basins are thus positioned to catch water from the nipple assemblies.

### CROSS-REFERENCE AND INCORPORATION BY REFERENCE

This patent application claims the benefit of domestic priority of: (1) U.S. Provisional Application Ser. No. 60/783,161, filed Mar. 16, 2006, and entitled “Watering System For Turkeys”; U.S. Provisional Application Ser. No. 60/787,041, filed Mar. 29, 2006, and entitled “Watering System For Turkeys”; and U.S. Provisional Application Ser. No. 60/867,326, filed Nov. 27, 2006, and entitled “Watering Nipple Assembly For Use In A Watering System For Turkeys”. U.S. Provisional Application Ser. Nos. 60/783,161, 60/787,041 and 60/867,326 are hereby incorporated by reference.

### FIELD OF THE INVENTION

The present invention generally relates to a system for providing liquids to birds. More specifically, the present invention relates to a system for providing potable water to turkeys within a turkey house.

### BACKGROUND OF THE INVENTION

Approximately twenty to thirty years ago, birds, such as turkeys and chickens, were presented potable water in traditional cup drinkers, troughs and bell drinkers. Presenting potable water to the birds in such structures, however, caused numerous problems. Namely, the open potable water could become dirty, stale and contaminated. The bell drinker was hard to clean and often had to be moved within the house to keep the floors dry. Cup drinkers stayed cleaner and the floors stayed dryer, however, the supply valve was located in the cut. Any contamination that was present in the standing water had the potential to enter the supply pipe via the valve.

When the growers began using nipples, the birds' rate of gain suffered. It was readily acknowledged that birds did not get as much water from a nipple as they did from an open drinker. This resulted in less feed consumption and lower body weights. Bird health, feed conversion and other positives, however, led to the change to nipples. Thus, by the early to mid-1990's, every new poultry house and many of the re-worked houses had gone to nipples.

Turkeys have their own unique set of opportunities in watering. They are traditionally watered from bell drinkers. In the past, nipple experiments on turkeys have resulted in very light birds. It has been concluded that the following factors are among the primary reasons why:

1. Turkeys stay in the house so long that any shortcoming of the equipment is magnified. A chicken may be in the house for fifty (50) days until slaughter, while tom turkeys can be there for one-hundred forty (140) days. When nipples reduce the rate of gain per day, that rate of gain is multiplied by 140 days rather than 50 days.

2. Turkeys are expected to weigh approximately forty (40) pounds near slaughter and consume large quantities of water everyday. A chicken at seven (7) weeks of age will consume approximately sixty-four thousandths (0.064) of a gallon of water per day. A turkey at eighteen (18) weeks of age will consume approximately twenty-four hundredths (0.24) of a gallon of water per day. The drinker will need to provide this potable water quick enough or the bird will stop drinking from boredom, rather than being completely satisfied. For example, if a person is thirsty, he/she will stand at a drinking fountain and only drink a portion of the water coming out. After standing there for a period of time, the person will decide it was enough and move on. If, however, the person had a glass of water already full, it would be more likely that the person would drink much more water in a shorter period of time. If a person fills a glass under a drinking fountain, the person will find out how long it really takes to fill the cup (even if one-hundred percent (100%) of the water is caught).

3. Turkeys are “dumb”. Turkeys will peck at anything shiny, but some don't make the connection that they can get potable water that way. They don't “learn” how to effectively use nipples. Some percentage of the birds may not even try to drink from the nipple.

4. Turkeys are so large that they are physically very hard on equipment. Cup drinkers have been tried instead of bell drinkers. However, they need to be replaced very often because they wear out.

Therefore, an improved system for providing potable water to turkeys within a turkey house is needed. The present invention provides such a system. Features and advantages of the present invention will become apparent upon a reading of the attached specification, in combination with a study of the drawings.

### SUMMARY OF THE INVENTION

Briefly, and in accordance with the foregoing, the invention provides a watering system for providing water to turkeys. The watering system includes an elongated channel assembly and an elongated pipe assembly for receiving the water. The elongated pipe assembly is at least partially covered and supported by the elongated channel assembly. A hangar has a bottom member and first and second extension members extending from opposite ends of the bottom member. The bottom member of the hangar is wrapped around at least a portion of the elongated channel assembly and at least a portion of the elongated pipe assembly. The first and second extension members are configured to be secured to one another above the elongated channel assembly and to be secured to a cable assembly such that the watering system can be raised or lowered via the cable assembly. First and second spaced apart nipple assemblies are connected to the elongated pipe assembly. Each nipple assembly is configured to provide the turkeys with access to the water within the elongated pipe assembly when the birds trigger the nipple assemblies. A catch cup assembly is secured to the elongated channel assembly. The catch cup assembly has a first catch basin which is positioned below the first nipple assembly in order to catch water from the first nipple assembly when the turkeys trigger the first nipple assembly. The catch cup assembly further has a second catch basin which is positioned below the second nipple assembly in order to catch water from the second nipple assembly when the birds trigger the second nipple assembly.

### BRIEF DESCRIPTION OF THE DRAWINGS

The features of the invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 illustrates a side view of a watering system of the invention;

FIG. 2 is a side view of a pipe member included in the watering system;

FIG. 3 is a side view of a channel member included in the watering system;

FIG. 4 is a end view of the channel member;

FIG. 5 is an enlarged view of a portion of the channel member taken from circle 5 of FIG. 4;

FIG. 6 is a perspective view of a bracket member included in the watering system;

FIG. 7 is a side view of a pipe coupling member included in the watering system;

FIG. 8 is an end view of the pipe coupling member;

FIG. 9 is a cross-sectional view of the pipe coupling member taken along line 9-9 of FIG. 8;

FIG. 10 is a perspective view of an insert coupling included in the watering system;

FIG. 11 is a side view of the insert coupling;

FIG. 12 is a cross-sectional view of a pipe coupling assembly included in the watering system;

FIG. 13 is a side view illustrating the watering system being hung from a ceiling of a poultry house by a cable assembly;

FIG. 14 is an alternative side view illustrating the watering system being hung by a cable assembly;

FIGS. 15 and 16 are perspective views of a hangar member included in the watering system;

FIG. 17 is a first side view of the hangar member;

FIG. 18 is a second side view of the hangar member;

FIG. 19 illustrates birds, namely turkeys, standing on a floor and drinking from the watering system;

FIG. 20 is a side view of a nipple assembly included in the watering system;

FIG. 21 is a cross-sectional view of the nipple assembly taken along line 21-21 of FIG. 20;

FIG. 22 is an end view of a portion of the watering system illustrating the connection of the channel member, the pipe member, the nipple assembly, and a catch cup assembly;

FIG. 23 is a perspective view of a contact ball included in the nipple assembly;

FIG. 24 is a side view of the contact ball;

FIG. 25 is a cross-sectional view of the contact ball taken along line 25-25 of FIG. 24;

FIG. 26 is a side view of a portion of the watering system illustrating the connection of the channel member, the pipe member, the nipple assembly, and the catch cup assembly;

FIG. 27 is a perspective view of a double catch cup of the catch cup assembly;

FIG. 28 is a top view of the double catch cup;

FIG. 29 is a cross-sectional view of the double catch cup taken along line 29-29 of FIG. 28;

FIG. 30 is a cross-sectional view of the double catch cup taken along line 30-30 of FIG. 28;

FIG. 31 is a cross-sectional view of the double catch cup taken along line 31-31 of FIG. 30;

FIG. 32 is a perspective view of a support member of the catch cup assembly;

FIG. 33 is a front view of the support member;

FIG. 34 is a rear view of the support member;

FIG. 35 is a first side view of the support member; and

FIG. 36 is a second side view of the support member.

### DETAILED DESCRIPTION OF THE ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated and described herein.

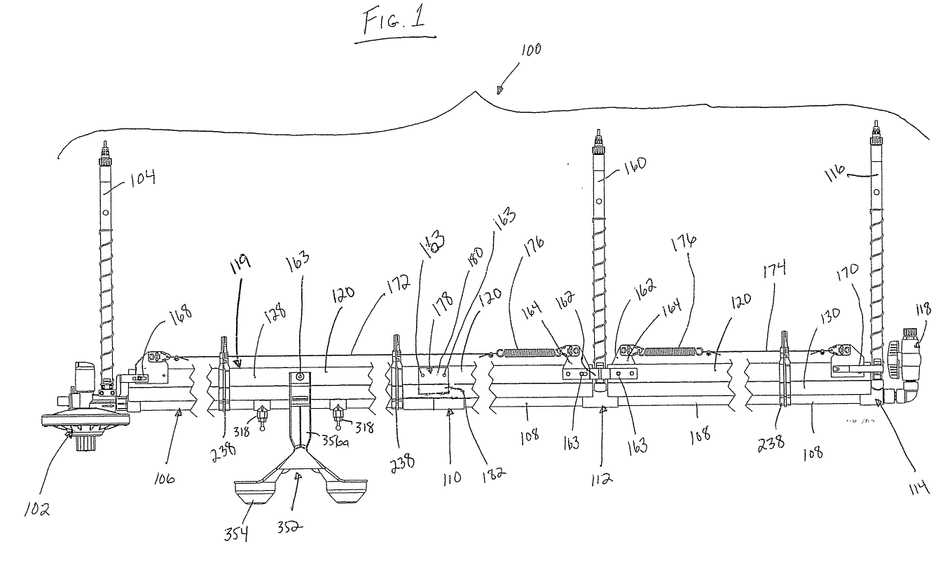

The invention provides a watering system 100, illustrated in FIG. 1, for providing potable water to poultry, namely turkeys, within a poultry house. In a poultry house, the watering system 100 would generally run the entire length of the house, typically on the order of about four hundred (400) feet long. Two such watering systems 100 preferably would typically run within a single poultry house, being separated by a predetermined distance, although it is to be understood that more or less such watering systems 100 could be provided within a single poultry house as desired.

The watering system 100 includes a pressure regulator 102 connected to a water source (not shown) for regulating the pressure of water entering the watering system 100. The pressure regulator 102 includes a sight tube 104 which allows for visual inspection of the amount of water pressure entering the watering system 100.

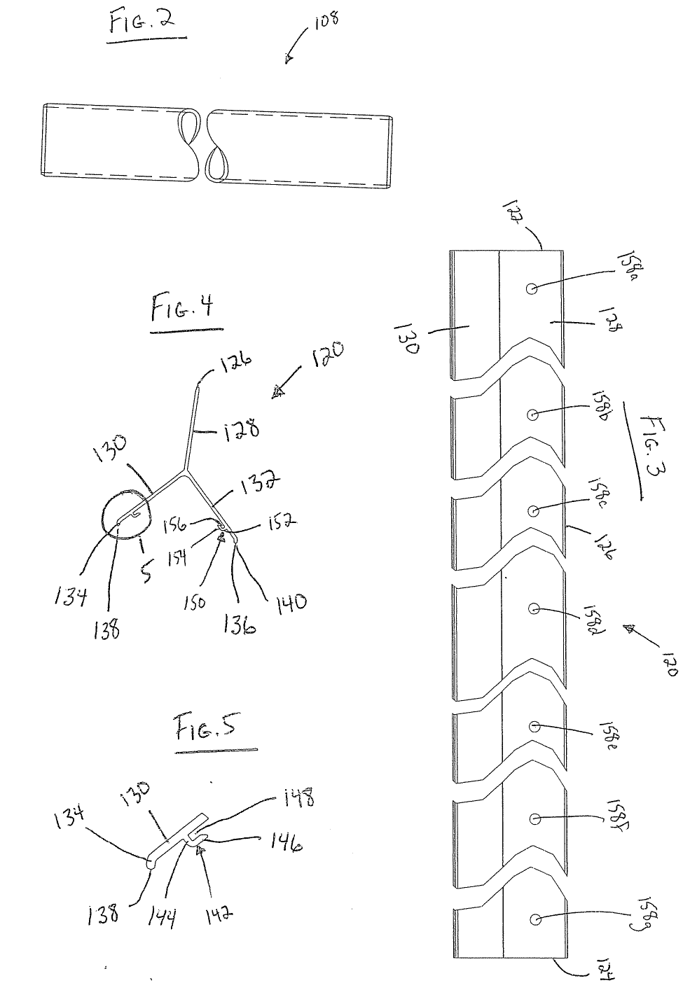

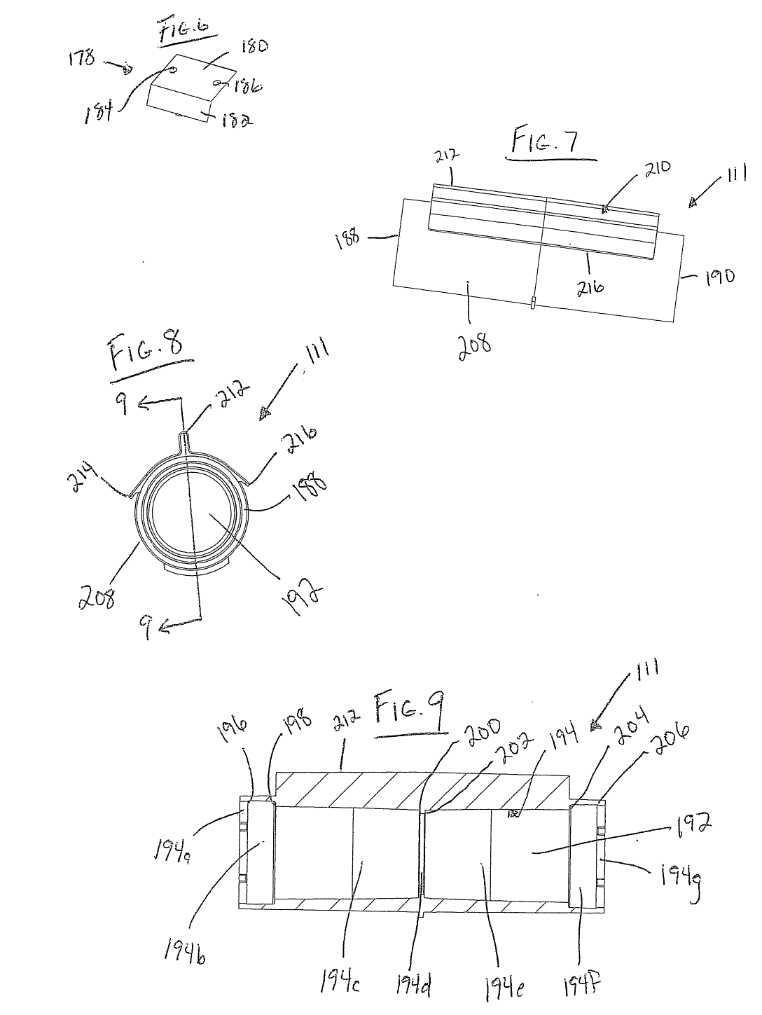

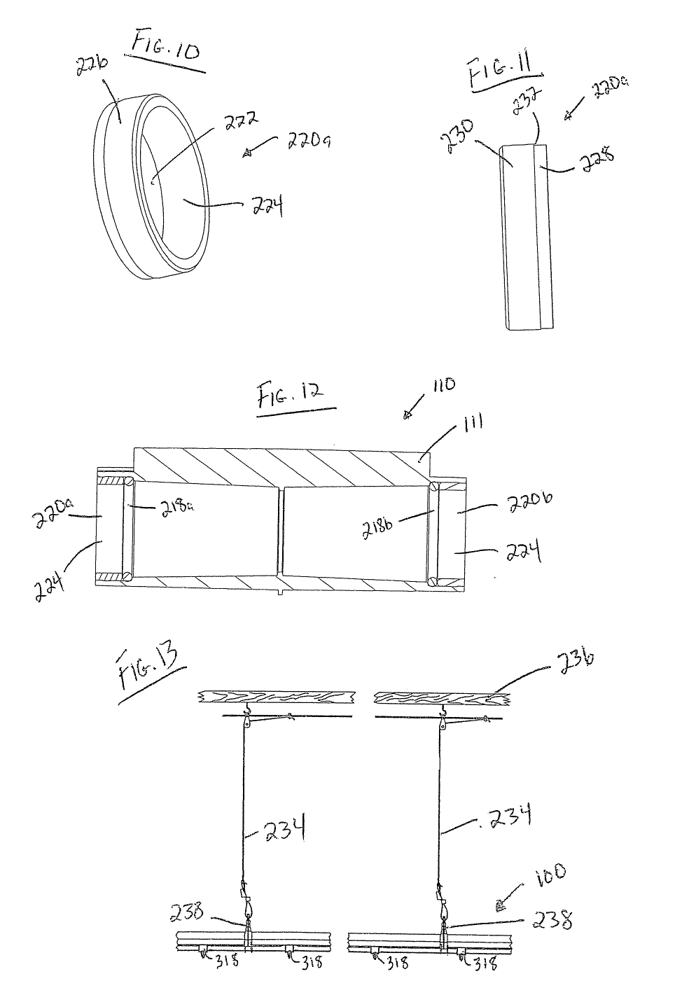

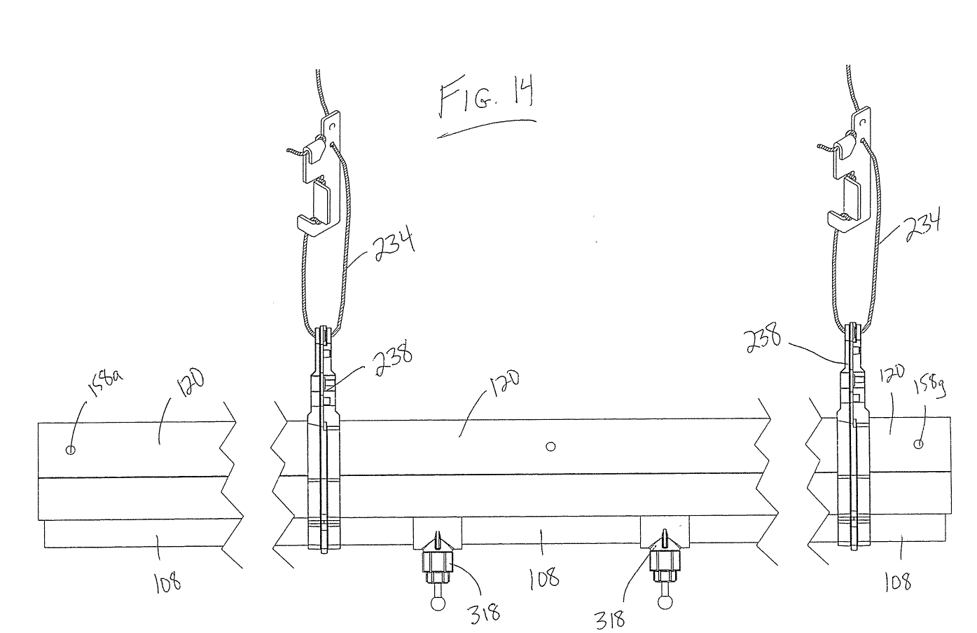

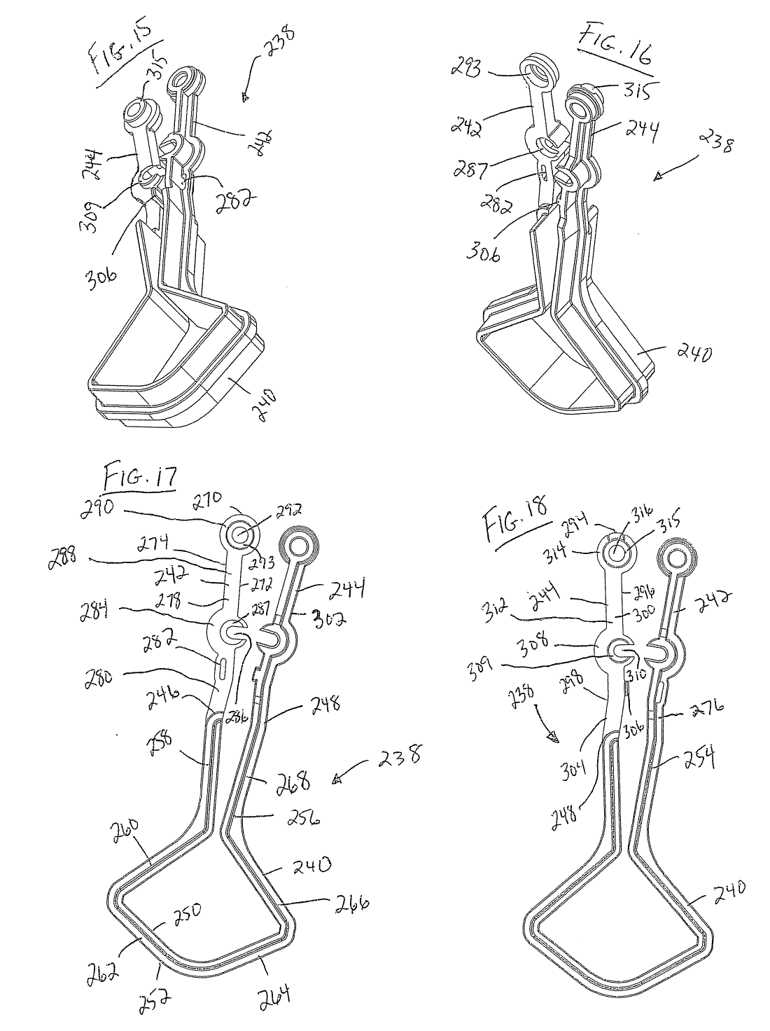

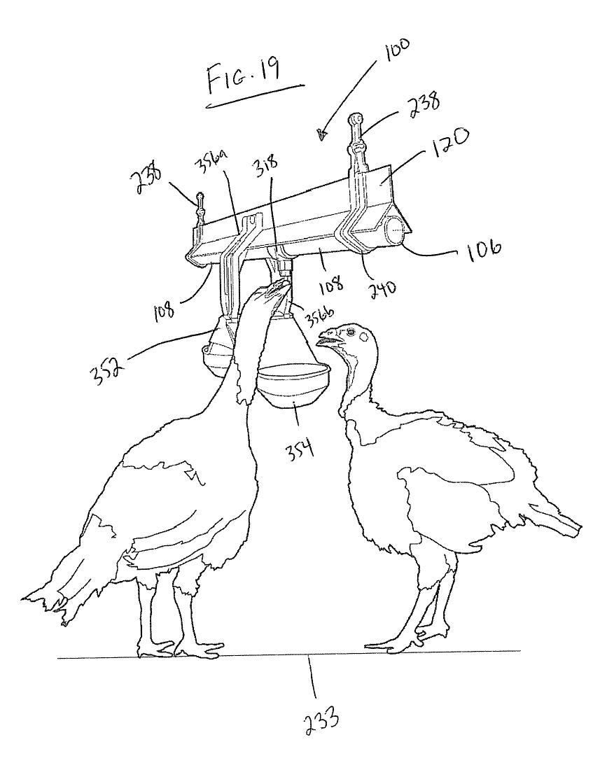

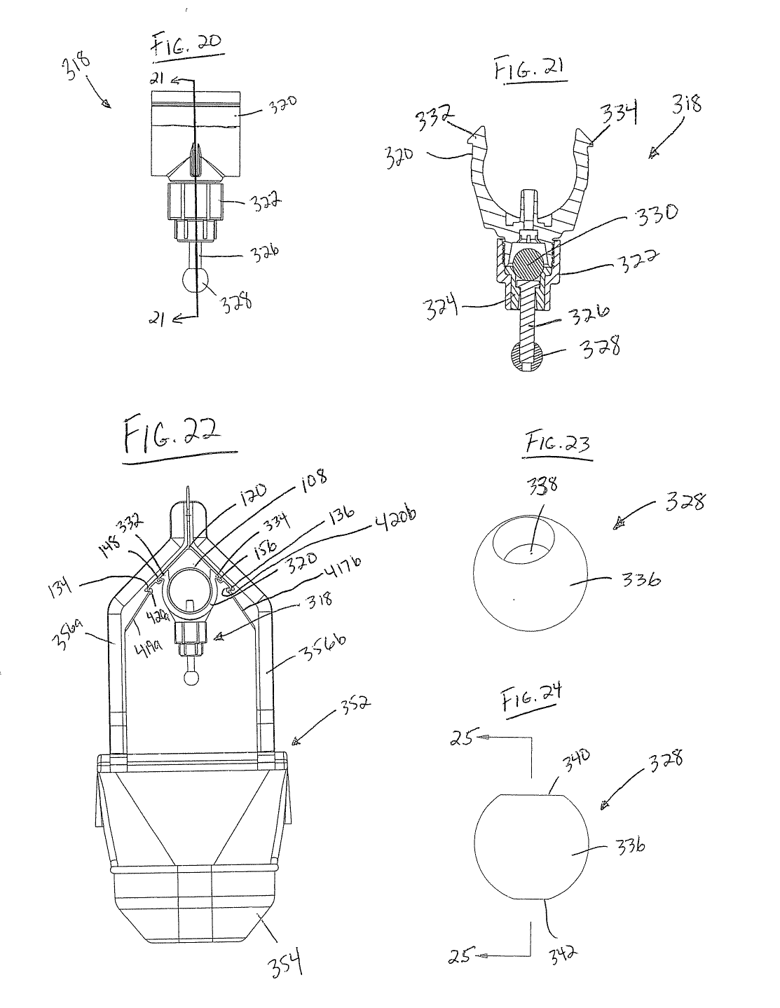

The pressure regulator 102 is connected to a first end of an elongated pipe assembly 106 which is formed of a plurality of elongated pipe members 108 connected end to end by either a horizontal pipe coupling assembly 110 or a T-shaped pipe coupling 112. Each pipe member 108, as illustrated in FIG. 2, preferably has first and second ends, an outer surface and an inner surface. A length of each pipe member 108 from the first end to the second end is preferably approximately 119.75 inches. An outer diameter of each pipe member 108 defined by the outer surface is preferably approximately 1.315 inches. An inner diameter of each pipe member 108 defined by the inner surface is preferably approximately 1.287 inches. Thus, a thickness of the pipe wall, defined between the inner and outer surfaces, is preferably approximately 0.063 inches. The outer surface at the first and second ends of each pipe member 108 is preferably chamfered toward the inner surface, preferably at a 60 degree angle.

The T-shaped pipe coupling 112 is known in the art and, therefore, neither the T-shaped pipe coupling 112 nor the connection of the elongated pipe members 108 to the T-shaped pipe coupling 112 will be described in detail herein. A second, opposite end of the elongated pipe assembly 106 is connected to an L-shaped pipe coupling 114. The L-shaped pipe coupling 114 is known in the art and, therefore, neither the L-shaped pipe coupling 114 nor the connection of an elongated pipe member 108 to the L-shaped pipe coupling 114 will be described in detail herein. The L-shaped pipe coupling 114 has a sight tube 116 extending upwardly therefrom which allows for visual inspection of the amount of water pressure exiting the watering system 100. A water stop 118 is also connected to the L-shaped pipe coupling 114 to prevent water from flowing past the water stop 118. If desired, the pressure regulator 102 can be configured to allow water to enter the watering system 100 at the same pressure as it enters the pressure regulator 102 in order to flush the elongated pipe assembly 106. The water stop 118 can be configured to be opened in order to allow the water to be flushed out of the second end of the elongated pipe assembly 106.

The watering system 100 further includes an elongated channel assembly 119 which is formed of a plurality of channel members 120 connected end to end. Each channel member 120 is preferably formed of extruded aluminum. As best illustrated in FIGS. 3-5, each channel member 120 has a first side end 122 and a second side end 124 and a length of the channel member 120 from the first side end 122 to the second side end 124 is preferably approximately 120.125 inches. Each channel member 120 has a top end 126 which extends from the first side end 122 to the second side end 124. The top end 126 is preferably rounded. A first leg member 128 of the channel member 120 extends straight downwardly from the top end 126 and connects to both second and third leg members 130, 132 of the channel member 120. Each of the first, second and third leg members 128, 130, 132 are extended, preferably by ½ inch, compared to the three leg members of a prior art heavy duty support channel manufactured for use in a watering assembly used for poultry smaller than turkeys, such as chickens.

Each of the second and third leg members 130, 132 extend angularly outwardly and downwardly from the first leg member 128 and connects to fourth and fifth leg members 134, 136 of the channel member 120, respectively, such that the second and third leg members 130, 132 are preferably approximately perpendicular to one another. The connection between the second and third leg members 130, 132 is preferably rounded. An angle between the first leg member 128 and the second leg member 130 is preferably approximately 135 degrees and an angle between the first leg member 128 and the third leg member 132 is preferably approximately 135 degrees. The connection between the first and second leg members 128, 130 and between the first and third leg members 128, 132 is preferably rounded.

The fourth leg member 134 extends straight downwardly from the second leg member 130 to a first bottom end 138 of the channel member 120 and the fifth leg member 136 extends straight downwardly from the third leg member 132 to a second bottom end 140 of the channel member 120. The fourth and fifth leg members 134, 136 are thus parallel to one another and are preferably separated from one another by approximately 2.497 inches. The fourth and fifth leg members 134, 136 preferably extend downwardly approximately 0.10 inches. The connection between the second and fourth leg members 130, 134 and between the third and fifth leg members 132, 136 is preferably rounded.

The thickness of the first, second, third, fourth and fifth leg members 128, 130, 132, 134, 136 is preferably approximately 0.065 inches.

A first flange member 142 extends inwardly from the second leg member 130. The first flange member 142 has a first portion 144 and a second portion 146. The first portion 144 extends angularly downwardly and inwardly, preferably perpendicular, from the second leg member 130, such that the first portion 144 is preferably parallel to the third leg member 132 and preferably separated from one another by approximately 1.466 inches. The second portion 146 extends angularly upwardly and inwardly, preferably perpendicular, from the first portion 144, such that the second portion 146 is preferably parallel to the second leg member 130 and preferably separated from one another by approximately 0.06 inches. The connection between the first and second portions 144, 146 is preferably rounded. Thus, a slot 148 is provided between the second leg member 130 and the first and second portions 144, 146 of the first flange member 142. The end of the second portion 146 at the opening of the slot 148 is preferably chamfered. The thickness of the first and second portions 144, 146 of the first flange member 142 is preferably approximately 0.045 inches.

A second flange member 150 extends inwardly from the third leg member 132. The second flange member 150 has a first portion 152 and a second portion 154. The first portion 152 extends angularly downwardly and inwardly, preferably perpendicular, from the third leg member 132, such that the first portion 152 is preferably parallel to the second leg member 130 and preferably separated from one another by approximately 1.466 inches. The second portion 154 extends angularly upwardly and inwardly, preferably perpendicular, from the first portion 152, such that the second portion 154 is preferably parallel to the third leg member 132 and preferably separated from one another by approximately 0.06 inches. The connection between the first and second portions 152, 154 is preferably rounded. Thus, a slot 156 is provided between the third leg member 132 and the first and second portions 152, 154 of the second flange member 150. The end of the second portion 154 at the opening of the slot 156 is preferably chamfered. The thickness of the first and second portions 152, 154 of the second flange member 150 is preferably approximately 0.045 inches.

Thus, the channel member 120 is generally Y-shaped in configuration.

The channel member 120 preferably has a plurality of apertures 158 provided through the first leg member 128, preferably seven apertures 158a, 158b, 158c, 158d, 158e, 158f, 158g. Each aperture 158a, 158b, 158c, 158d, 158e, 158f, 158g are preferably provided at a distance of approximately 0.84 inches below the top end 126 and have a diameter of approximately 0.281 inches. Aperture 158a is preferably provided at a distance of 1.0 inch from the first end 122 of the channel member 120; aperture 158b is preferably provided at a distance of 20.06 inches from the first end 122 of the channel member 120; aperture 158c is preferably provided at a distance of 30.06 inches from the first end 122 of the channel member 120; aperture 158d is preferably provided at a distance of 60.06 inches from the first end 122 of the channel member 120; aperture 158e is preferably provided at a distance of 90.06 inches from the first end 122 of the channel member 120; aperture 158f is preferably provided at a distance of 100.06 inches from the first end 122 of the channel member 120; and aperture 158g is preferably provided at a distance of 119.125 inches from the first end 122 of the channel member 120.

Where the T-shaped pipe couplings 112 connect adjacent pipe members 108 together, a sight tube 160 extends upwardly from the T-shaped pipe coupling 112 to allow for visual inspection of the amount of water pressure at that point of the watering system 100. The sight tube 160 prevents adjacent channel members 120 from being directly connected to one another (with the second side end 124 of one channel member 120 abutting against, or facing in close proximity, the first side end 122 of the other channel member 120). As such, connecting brackets 162 extend between the adjacent channel members 120 and are secured to the adjacent channel members 120 by fastening assemblies 163, such as bolts and nuts, with the bolts extending through the aperture 158g of one channel member 120 and through the aperture 158a of the adjacent channel member 120. Further apertures may be drilled through the first leg member 128 of the channel member 120 such that extra fastening assemblies 163 can secure the connecting bracket 162 to the channel members 120 as desired, which allows for flexibility for where the T-shaped pipe coupling 112 and the sight tube 160 are provided along the length of the watering system 100. It should be noted that, if desired, the T-shaped pipe coupling 112 and the sight tube 160 do not have to be included in the watering system 100. The connecting brackets 162 have upwardly extending members 164 which extend upwardly on either side of the sight tube 160, one above one of the channel members 120 and the other above the other one of the channel members 120.

A first bracket member 168 is secured to the sight tube 104 and is connected to the channel member 120, proximate to the first end 122 thereof, most proximate to the sight tube 104. A second bracket member 170 is secured to the sight tube 116 and is connected to the channel member 120, proximate to the second end 124 thereof, most proximate to the sight tube 116. A first roost wire 172 extends from the first bracket member 168 to the first upwardly extending member 164 and a second roost wire 174 extends from the second upwardly extending member 166 to the second bracket member 170. The roost wires 172, 174 inhibit the poultry within the poultry house from sitting or resting on the watering system 100. It should be noted that if the T-shaped pipe coupling 112 and the sight tube 160 are not provided in the watering system 100, that only a single roost wire would be necessary which would extend from the first bracket member 168 to the second bracket member 170. If desired, a tension spring 176 may be connected to each roost wire 172, 174 to ensure that the roost wires 172, 174 remain taut.

Where the horizontal pipe coupling assemblies 110 connect adjacent pipe members 108 together, sight tubes are not provided at these connections, but rather a bracket member 178 is provided which allows for the adjacent channel members 120 to be directly connected to one another (with the second side end 124 of one channel member 120 abutting against, or facing in close proximity, the first side end 122 of the other channel member 120). As best illustrated in FIG. 6, the bracket member 178 has first and second portions 180, 182 with the second portion 182 extending angularly downwardly and outwardly from the first portion 180. The first portion 180 is configured to have first and second apertures 184, 186 provided therethrough. The first portion 180 of the bracket member 178 is configured to be positioned against the first leg members 128 of the adjacent channel members 120 and the second portion 182 of the bracket member 178 is configured to be positioned against either the second or third leg members 130, 132 (depending on which side of the channel member 120 the bracket member 178 is placed on) of the adjacent channel members 120. The first aperture 184 is configured to be aligned with one of the apertures 158a, 158g on one of the channel members 120 and the second aperture 186 is configured to be aligned with the other one of the apertures 158a, 158g on the adjacent channel member 120. Fastener assemblies 163, such as bolts and nuts, are provided to secure the bracket member 178 to the adjacent channel members 120, with the bolts extending through the apertures 158a, 158g of the adjacent channel members 120 and through the apertures 184, 186 of the bracket member 178.

Each horizontal pipe coupling assembly 110 has a pipe coupling 111 which is preferably configured as illustrated in FIGS. 7-9 and is molded out of PVC for strength. The pipe coupling 111 has first and second ends 188, 190 with an aperture 192 extending therethrough from the first end 188 to the second end 190. The aperture 192 defines an aperture wall 194 which is configured such that the pipe coupling 111 has varying inner diameters from the first end 188 to the second end 190 thereof. From the first end 188, the aperture wall 194 has a first portion 194a which extends straight inwardly toward the second end 190 and which defines a first inner diameter of the aperture 192. A shoulder 196 is provided which connects the first portion 194a to a second portion 194b of the aperture wall 194. The second portion 194b extends straight inwardly toward the second end 190 from the shoulder 196 and defines a second inner diameter of the aperture 192 which is larger than the first inner diameter. A shoulder 198 is provided which connects the second portion 194b to a third portion 194c of the aperture wall 194. The third portion 194c tapers inwardly toward the second end 190 from the shoulder 198 and defines a third inner diameter of the aperture 192. As the third portion 194c is tapered, the third inner diameter of the aperture 192 is always changing, but is preferably always less than the first inner diameter. A shoulder 200 is provided which connects the third portion 194c to a fourth portion 194d of the aperture wall 194. The fourth portion 194d extends straight inwardly toward the second end 190 from the shoulder 200 and defines a fourth inner diameter which is smaller than the third inner diameter. Shoulders 202, 204, 206 are provided which are mirror images of the shoulders 200, 198, 196, respectively. Fifth, sixth and seventh portions 194e, 194f, 194g are provided which are mirror images of the third, second and first portions 194c, 194b, 194a, respectively, with the seventh portion 194g extending to the second end 190 of the pipe coupling 111.

The pipe coupling 111 has an outer generally cylindrical surface 208 which is configured to have a member 210 on a top thereof, which is preferably integrally formed with the remainder of the pipe coupling 111. The member 210 has a peak portion 212 provided at a center/top thereof and first and second extensions 214, 216 which extend outwardly from the outer cylindrical surface 208 of the pipe coupling 111.

First and second O-rings 218a, 218b are provided within the aperture 192 of the pipe coupling 111 with the first O-ring 218a being positioned against the second portion 194b of the aperture wall 194 and the shoulder 198. Likewise, the second O-ring 218b is positioned against the sixth portion 194f of the aperture wall 194 and the shoulder 204.

As best illustrated in FIGS. 10 and 11, first and second insert couplings 220a, 220b are provided within the aperture 192 of the pipe coupling 111. Each insert coupling 220a, 220b has an aperture 222 extending therethrough defining an aperture wall 224 defining a generally constant inner diameter of the insert couplings 220a, 220b. An outer surface 226 of the insert couplings 220a, 220b has first and second portions 228, 230 separated by a shoulder 232. The first portion 228 defines a smaller outer diameter of the insert couplings 220a, 220b than the second portion 230 defines. The first insert coupling 220a extends between the first end 188 of the pipe coupling 111 and the first O-ring 218a with the shoulder 232 being positioned against the shoulder 196, such that the first portion 228 is positioned against the second portion 194b and such that the second portion 230 is positioned against the first portion 194a. Likewise, the second insert coupling 220b extends between the second end 190 of the pipe coupling 111 and the second O-ring 218a with the shoulder 232 being positioned against the shoulder 204, such that the first portion 228 is positioned against the sixth portion 194f and such that the second portion 230 is positioned against the seventh portion 194g. The insert couplings 220a, 220b thus secure the O-rings 218a, 218b in place within the aperture 192 of the pipe coupling 111.

The pipe coupling assembly 110 thus includes the pipe coupling 111, the O-rings 218a, 218b, and the insert couplings 220a, 220b, as illustrated in FIG. 12.

Adjacent pipe members 108 are positioned and secured within the aperture 192 of the pipe coupling assembly 110. One end of one pipe member 108 is inserted through the insert coupling 220a, through the O-ring 218a, and into the third portion 194c of the aperture 192. The opposite end of the other pipe member 108 is inserted through the insert coupling 220b, through the O-ring 218b, and into the fifth portion 194e of the aperture 192. The ends of the adjacent pipe members 108 are prevented from contacting one another by the shoulders 200, 202 and the fourth portion 194d provided therebetween. The O-rings 218a, 218b provide a water tight seal at each end of the pipe coupling assembly 110 such that water flowing through one of the pipe members 108 will flow into the adjacent pipe member 108 without leaking out of the pipe coupling assembly 110. The configuration of the aperture 192 of the pipe coupling assembly 110 allows for the expansion and contraction of the pipe members 108, depending on climate conditions, which assists in preventing the possible buckling of the watering assembly 100.

The peak 212 of the member 210 on the pipe coupling 111 is configured to be positioned against the connection of the second and third leg members 130, 132 of the channel member 120 in order to provide a rigid connection between the pipe coupling assembly 110 and the channel member 120. The first and second extension 214, 216 of the member 210 are configured to be inserted into the slots 148, 156 defined by the channel member 120 in order to support the pipe coupling assembly 110, and thus, the pipe assembly 106.

As illustrated in FIGS. 13 and 14, the watering system 100 is held or suspended above the floor 233 of the poultry house by a cable assembly 234 secured to a ceiling or roof truss 236 of the poultry house. The cable assembly 234 may be configured to be winchable, if desired, such that the watering system 100 could be raised or lowered relative to the floor 233 of the poultry house. The cable assembly 234 is configured to be secured to one or more hangars 238 of the watering system 100.

As illustrated in FIGS. 15-18, each hangar 238 is preferably formed of polypropylene and has a bottom member 240 and first and second extensions 242, 244. The bottom member 240 has first and second ends 246, 248, inner and outer surfaces 250, 252, and first and second side edges 254, 256. The bottom member 240 has a first portion 258 which extends downwardly from the first end 246 to a second portion 260 of the bottom member 240. The second portion 260 extends downwardly and outwardly from the first portion 258 to a third portion 262 of the bottom member 240. The third portion 262 extends downwardly and inwardly from the second portion 260 to a fourth portion 264 of the bottom member 240. The fourth portion 264 extends upwardly and outwardly from the third portion 262 to a fifth portion 266 of the bottom member 240. The fifth portion 266 extends upwardly and inwardly from the fourth portion 264 to a sixth portion 268 of the bottom member 240. The sixth portion 268 extends upwardly from the fifth portion 266 to the second end 248 of the bottom member 240. The connections between the first and second portions 258, 260, between the second and third portions 260, 262, between the third and fourth portions 262, 264, between the fourth and fifth portions 264, 266, and between the fifth and sixth portions 266, 268 are preferably rounded. The inner surfaces 260 of the first and sixth portions 258, 268 are configured to be flexed apart from one another, but when not flexed apart from one another are generally configured to be parallel to, and facing, one another. The second, third, fourth and fifth portions 260, 262, 264, 266 generally are formed in a diamond configuration when the first and sixth portions 258, 268 are not flexed away from one another. The outward flexing of the first and/or sixth portions 258, 268 may cause the flexing of the second and/or fifth portions 260, 266 as well.

The first extension 242 is preferably integrally formed with the bottom member 240 and extends upwardly from the first end 246 of the bottom member 240 from the first side edge 254 to generally a midpoint of the first end 246 between the first and second side edges 254, 256. The first extension 242 has a top 270, inner and outer surfaces 272, 274, and first and second side edges 276, 278. The inner and outer surfaces 272, 274 are generally continuations of the inner and outer surfaces 250, 252 of the bottom member 240, respectfully, and the first side edge 276 is generally a continuation of the first side edge 254 of the bottom member 240. The first extension 242 has a first extending portion 280 which extends upwardly from the first end 246 of the bottom member 240. The first extending portion 280 has an aperture 282 provided therethrough from the first side edge 276 to the second side edge 278. A generally C-shaped portion 284 extends upwardly from the first extending portion 280 and has a slot 286 which has its opening defined in the first and second side edges 276, 278 and in the inner surface 272. A pocket 287 is defined within the slot 286 and is open to the inner surface 272 and to the second side edge 278. A second extending portion 288 extends upwardly from the C-shaped portion 284 to an O-shaped portion 290. The O-shaped portion 290 extends to the top 270 and has an aperture 292 extending therethrough from the first side edge 276 to the second side edge 278. The aperture 292 defines a pocket 293 which is open to the second side edge 278.

The second extension 244 is preferably integrally formed with the bottom member 240 and extends upwardly from the second end 248 of the bottom member 240 from the second side edge 256 to generally a midpoint of the second end 248 between the first and second side edges 254, 256. The second extension 244 has a top 294, inner and outer surfaces 296, 298, and first and second side edges 300, 302. The inner and outer surfaces 296, 298 are generally continuations of the inner and outer surfaces 250, 252 of the bottom member 240, respectively, and the second side edge 302 is generally a continuation of the second side edge 256 of the bottom member 240. The second extension 244 has a first extending portion 304 which extends upwardly from the second end 248 of the bottom member 240. The first extending portion 304 has a protrusion 306 extending therefrom. A generally C-shaped portion 308 having a protrusion 309 extending outwardly from the first side edge 300 extends upwardly from the first extending portion 304 and has a slot 310 which has its opening defined in the first and second side edges 300, 302 and in the inner surface 296. A second extending portion 312 extends upwardly from the C-shaped portion 308 to an O-shaped portion 314. The O-shaped portion 314 having a protrusion 315 extending outwardly from the first side edge 300 extends to the top 294 and has an aperture 316 extending therethrough from the first side edge 300 to the second side edge 302.

As best illustrated in FIGS. 1, 14 and 19, each hangar 238 is configured to wrap around the pipe assembly 106 and the channel member 120. The hangar 238 is configured such that the pipe assembly 106 will rest on the inner surface 250 of the bottom member 240 at the rounded connection between the third and fourth portions 262, 264 thereof. The hangar 238 is further configured such that the second and fifth portions 260, 266 thereof will rest against and on top of the second and third leg members 130, 132, respectively, of the channel member 120. The hangar 238 is also further configured such that the first and sixth portions 258, 268 thereof will rest against the opposite surfaces of the first leg member 128 of the channel member 120. The hangar 238 is secured to itself by inserting the protrusion 306 on the first extending portion 304 of the second extension member 244 into the aperture 282 of the first extending portion 280 of the first extension member 242; by inserting the protrusion 309 on the C-shaped portion 308 of the second extension member 244 into the pocket 287 of the C-shaped portion 284 of the first extension member 242 such that the slots 286, 310 are aligned; and by inserting the protrusion 315 on the O-shaped portion 314 of the second extension member 244 into the pocket 293 of the O-shaped portion 290 of the first extension member 242 such that the apertures 292, 316 are aligned. The protrusion 315 on the O-shaped portion 314 of the second extension member 244 is configured to be snap fit into the pocket 293 of the O-shaped portion 290 of the first extension member 242 by any suitable means, such as by angled surfaces, such that the hangar 238 is secured to itself.

As illustrated in FIG. 1, the anti-roost wires 172, 174 are configured to be positioned through the slots 286, 310 of the hangar 238 in order to provide a guide for the anti-roost wires 172, 174, as well as a boundary for limiting unimpeded movement of the anti-roost wires 172, 174. The anti-roost wires 172, 174 can advantageously be secured in position through the slots 286, 310 either during the assembly of the watering system 100, e.g., when the hangar 238 is secured to itself, or after the assembly of the watering system 100, e.g, by feeding the anti-roost wires 172, 174 through the slots 286, 310. The cable assembly 234 can be secured to the hangar 238 through the apertures 292, 316 thereof in order to then suspend or position the watering assembly 100 above the floor 233 and below the ceiling 236 at predetermined distances. A varying number of hangars 238 may be provided along the length of the watering assembly 100 as desired in order to properly support the watering system 100, although each hangar 238 is preferably spaced apart from an adjacent hangar 238 by approximately eight (8) feet or ten (10) feet.

The watering system 100 includes a plurality of nipple assemblies 318 which allow the birds, e.g., turkeys, within the poultry house to obtain water from the watering system 100. As best illustrated in FIGS. 20-24, each nipple assembly 318 includes a valve saddle 320, a cap 322, a valve seat 324, a valve pin 326, a contact ball 328, and a ball valve 330. The valve saddle 320 is secured to the elongated pipe assembly 106 in a manner known in the art. As illustrated in FIG. 22, similar to the pipe coupling 110, the valve saddle 320 has first and second extensions 332, 334 which are configured to be inserted into the slots 148, 156 defined by the channel member 120 in order to support the nipple assemblies 318, and thus, the pipe assembly 106, to which the nipple assemblies 318 are secured.

The cap 322 is secured to the valve saddle 320, preferably by threading, and preferably has a hex for removal with standard tools. The valve seat 324 is secured within the cap 322. The valve pin 326 extends through the cap 322 with the ball valve 330 being positioned on the valve pin 326 in the cap 322/valve saddle 320. The contact ball 328 is secured to an end of the valve pin 326 outside of the valve seat 324.

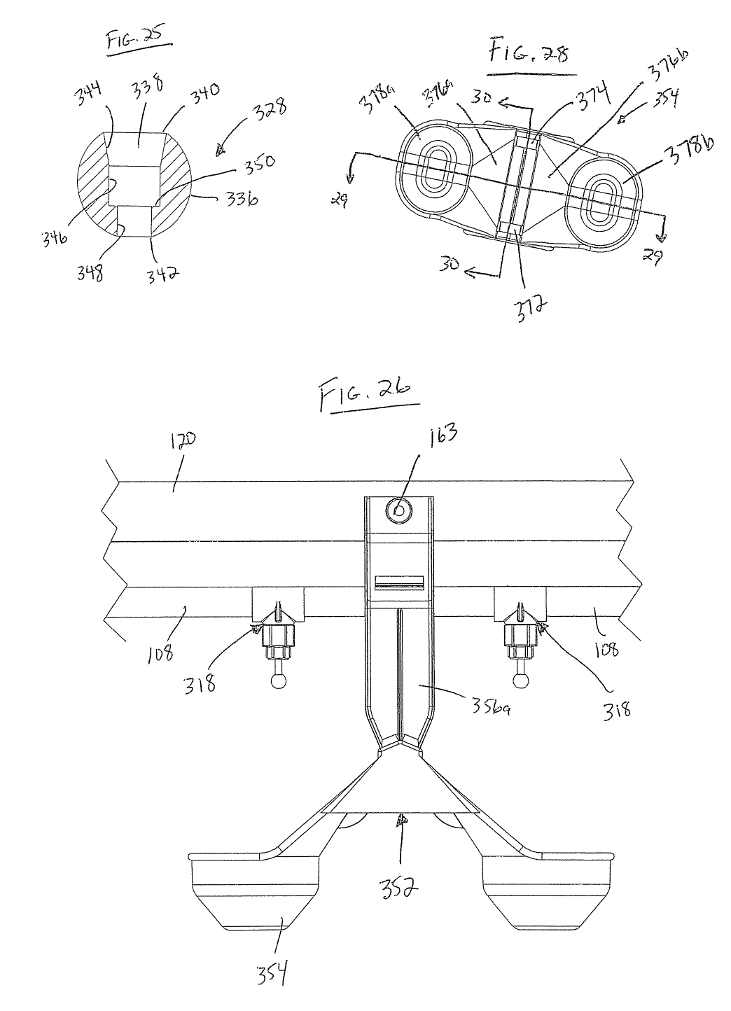

As best illustrated in FIGS. 23 and 25, the contact ball 328 is generally spherical and has an outer surface 336 defining a diameter of preferably approximately 0.4375 inches. The diameter of the contact ball 328 is derived by the bird's mouth size. It is important for the bird to be able to mouth the contact ball 328, but still close its beak so water does not fall out through the gap between the top and bottom beak, as generally illustrated in FIG. 19. The contact ball 328 has an aperture 338 which extends through the contact ball 328. One end of the aperture 338 defines a generally flat top 340 of the contact ball 328 while the other end defines a generally flat bottom 342 of the contact ball 328. Thus, were either the top 340 or bottom 342 of the contact ball 328 placed on a flat surface, the contact ball 328 would not roll. A distance from the top 340 to the bottom 342 is preferably approximately 0.392 inches. The aperture 338 at the top 340 has a diameter of preferably approximately 0.241 inches and the aperture 338 at the bottom 342 has a diameter of preferably approximately 0.130 inches.

The aperture 338 defines first, second and third wall portions 344, 346, 348. The first wall portion 344 extends angularly downwardly from the top 340 to the second wall portion 346, preferably at an angle of ten (10) degrees relative to vertical, such that a diameter of the aperture 338 at the connection of the first and second wall portions 344, 346 is approximately 0.196 inches. The second wall portion 346 extends straight downwardly from the first wall portion 344 to a shoulder 350 defined by the aperture 338, which connects the second and third wall portions 346, 348 to one another. The third wall portion 348 extends straight downwardly from the shoulder 350 to the bottom 342. The first wall portion 344 preferably has a vertical height of approximately 0.126 inches, the second wall portion 346 preferably has a vertical height of approximately 0.150 inches, and the third wall portion 348 preferably has a vertical height of approximately 0.115 inches.

As best illustrated in FIG. 22, the end of the valve pin 326 is pressed into the aperture 338 from the top 340 thereof such that the end of the valve pin 326 abuts against or faces the shoulder 350 and such that an end portion of the valve pin 326 is press fit against the second wall portion 346 defined by the aperture 338, such that the contact ball 328 is secured to the valve pin 326. The top 340 of the contact ball 328 is separated from a bottom of the cap 322/valve seat 320 by preferably approximately 0.43 inches. This dimension is preferable because it provides the birds with enough room that they can comfortably mouth or close on the contact ball 328 which allows water to wick into its mouth, as generally illustrated in FIG. 19. This is important because turkeys can have difficulties with aim. The contact ball 328 being a reasonable distance from the cap 322/valve seat 320 also makes it more apparent that it is the focal point for drinking.

With this nipple assembly 318, water comes out of the valve, down the valve pin 326, and around the outer surface 336 of the contact ball 328. Water is allowed to “wick” off into the bird's mouth better when the bird “mouths” or bites the contact ball 328 from the side, as illustrated in FIG. 19. The nipple assembly 318 may also be triggered by the bird pecking at the contact ball 328 such that the contact ball 328 is either moved vertically or angularly to displace the ball valve 330, thus allowing water to flow out of the valve. The diameter of the contact ball 328 is based on the bird having an adequate target to grab, but not being too big so the bird can't close on it to prevent spillage. The distance the contact ball 328 is away from the valve saddle 320 and cap 322 allows the bird to have a more distinguished target, or be more in the open so the bird can drink easier. The aperture 338 defined between the third wall portion 348 is provided for alignment purposes during assembly and further functions to hold a drop of water which attracts the birds to the nipple assembly 318. The design of the nipple assembly 318 permits the valve assembly to deliver water to the bird when it is actuated from the side. Water can be delivered to the bird accurately regardless of how the valve assembly is actuated. Due to water's wicking action, this valve assembly will deliver water to whatever location the bird makes contact with it. Thus, the birds are able to vertically lift the valve, bite it from the side, peck at it, or brush the outside of its beak with the valve.

The birds, of course, will not drink all of the water that flows out of the nipple assembly 318 such that the water will spill out of the nipple assembly 318 and toward the floor 233. As it is undesirable for sanitary purposes to have the water come into contact with the floor 233, and because some of the birds may be too “dumb” to figure out that activation of the nipple assembly 318 will provide them with water, the watering system 100 of the present invention is also outfitted with catch cup assemblies 352.

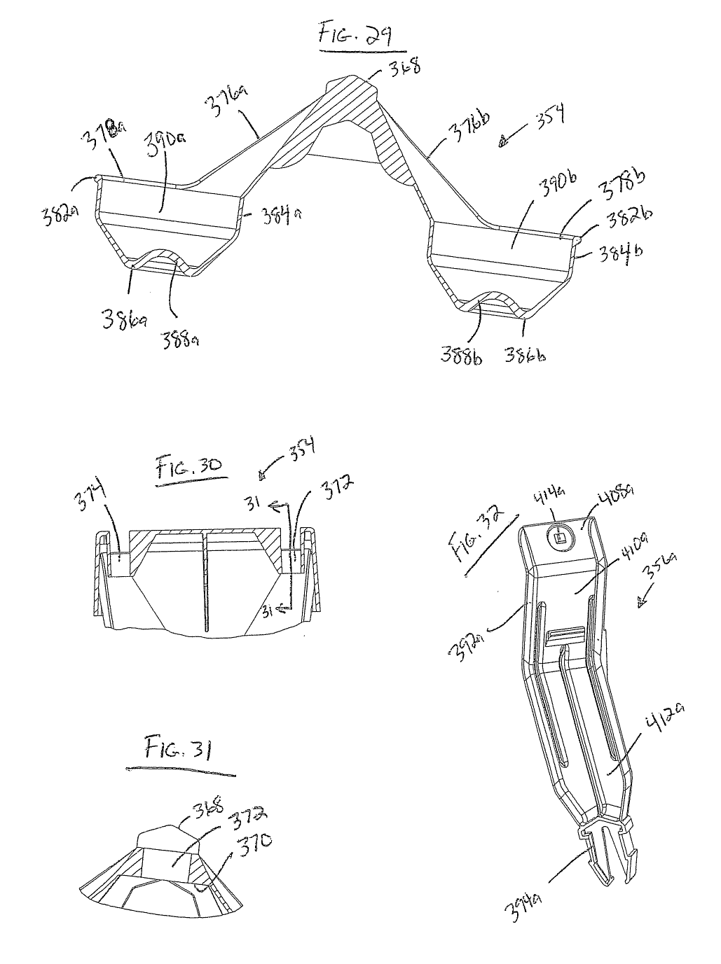

Each catch cup assembly 352 includes a dual catch cup 354 and a pair of support members 356a, 356b. As best illustrated in FIGS. 27-31, the dual catch cup 354 is preferably molded from polypropylene and has a middle member 358 having first and second ends 360, 362, first and second sides 364, 366, and top and bottom surfaces 368, 370. The middle member 358 also has first and second apertures 372, 374 extending therethrough from the top surface 368 to the bottom surface 370. The first aperture 372 is provided proximate to the first end 360 and the second aperture 374 is provided proximate to the second end 362.

The dual catch cup 354 further has first and second extending members 376a, 376b which extend angularly downwardly and outwardly from the first and second sides 364, 366, respectively, to first and second catch basins 378a, 378b, respectively. First and second shield members 380a, 380b may cover the first and second ends 360, 362, respectively, of the middle member 358, and be secured to the first and second extending members 376a, 376b.

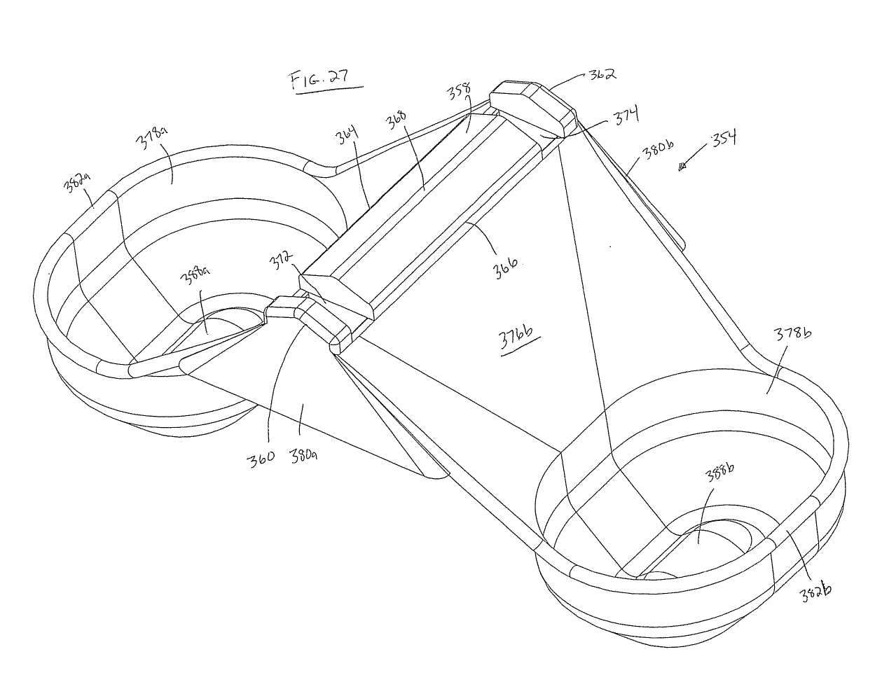

The first and second catch basins 378a, 378b preferably have an oval, elliptical or racetrack configuration when viewed from above, as illustrated in FIG. 28, such that a width of the catch basins 378a, 378b is preferably approximately 3.5 inches and a length of the catch basins 378a, 378b is preferably approximately 4.5 inches. Prior art catch cups only included a single catch basin and this oval design of the catch basins 378a, 378b is an improvement over single catch basin designs of the prior art which were typically circular in configuration, because the oval shape accommodates the head of a bird better. The catch basins 378a, 378b have an upper rim member 382a, 382b, with the first and second extending members 376a, 376b being secured to a least a portion, preferably half, of the upper rim members 382a, 382b. The catch basins 378a, 378b also have wall portions 384a, 384b which preferably first extend straight, vertically downwardly from the upper rim members 382a, 382b and then preferably extend angularly downwardly and inwardly to a bottom 386a, 386b of the catch basins 378a, 378b. The bottoms 386a, 386b preferably have portions 388a, 388b which are raised upwardly from the bottoms 386a, 386b, although the raised portions 388a, 388b need not be provided if desired. A preferred vertical distance from the upper rim member 382a, 382b to the raised portion 388a, 388b is approximately 1.525 inches. Thus, each catch basin 378a, 378b forms a pocket 390a, 390b into which the water from the nipple assemblies 318 can be received and held, as the catch basins 378a, 378b are positioned directly below and spaced apart from the nipple assemblies 318, thus preventing a substantial portion of the water exiting the nipple assemblies 318 and not directly drunk by the birds to still be used for drinking, as opposed to falling to the floor 233, which can cause sanitary problems within the poultry house. The birds can thus drink the water collected within the pockets 390a, 390b of the catch basins 378a, 378b.

The raised portions 388a, 388b assist in the prevention of water being splashed out of the catch basins 378a, 378b when the dual catch cup 354 is hit by a bird from any one of the sides of the dual catch cup 354. When hit, the raised portions 388a, 388b of the catch basins 378a, 378b interrupt or break the flow of water within the confines of the catch basins 378a, 378b, thus preventing or minimizing splashing over the upper rim members 382a, 382b of the catch basins 378a, 378b. The upper rim members 382a, 382b, the vertical portions of the wall portions 384a, 384b, and the overall oval shape of the catch basins 378a, 378b reduce the sloshing of water out of the catch basins 378a, 378b. The dual catch cup 352 design also promotes better bird activity within the poultry house by allowing easier movement of the birds through the house, and because it helps in attracting birds to the water.

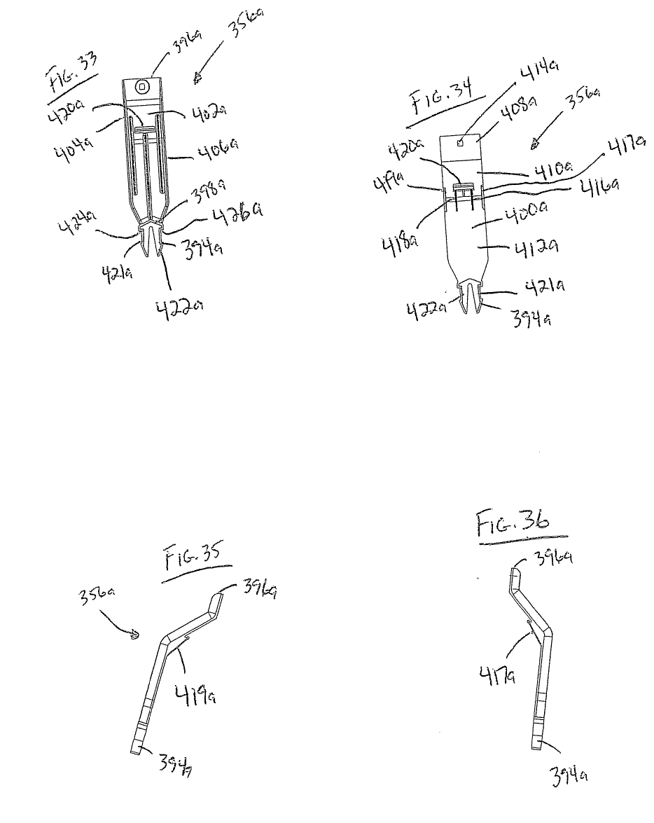

As support members 356a, 356b are identical to one another, only support member 356a will be described in detail herein with the understanding that the description of support member 356b would be identical. As illustrated in FIGS. 32-36, support member 356a is preferably molded from PVC for strength and has a bracket portion 392a and a prong portion 394a which are preferably integrally formed. The bracket portion 392a has upper and lower ends 396a, 398a, inner and outer surfaces 400a, 402a, and first and second sides 404a, 406a. The bracket portion 392a has a first portion 408a which extends straight downwardly from the upper end 396a to a second portion 410a of the bracket portion 392a. The second portion 410a extends angularly downwardly and outwardly from the first portion 408a to a third portion 412a of the bracket portion 392a. The third portion 412a extends straight downwardly, such that it is preferably parallel to the first portion 408a, to the lower end 398a. The connections between the first and second portions 408a, 410a and between the second and third portions 410a, 412a are preferably rounded.

An aperture 414a extends through the first portion 408a of the bracket portion 392a from the inner surface 400a to the outer surface 402a. Spaced-apart flanges 416a, 417a, 418a, 419a extend inwardly from the inner surface 400a of a portion of both the second and third portions 410a, 412a. The flanges 416a, 418a support a cut-out or flange 420a which is formed through the second portion 410a and which extends inwardly. Support and/or strengthening ribs may be provided along the outer surface 402a if desired.

The prong portion 394a extends downwardly from the lower end 398a of the bracket portion 392a. The prong portion 394a has a pair of spaced-apart, prong members 421a, 422a. The prong members 420a, 422a each have a ledge 424a, 426a formed along an outer edge thereof.

As illustrated in FIGS. 1 and 22, each support member 356a, 356b is configured to be positioned against the first leg member 128 of the channel member 120 such that the apertures 414a, 414b are in communication with one of the apertures 158b, 158c, 158d, 158e, 158f. Fastener assemblies 163, such as bolts and nuts, are provided to secure the support members 356a, 356b to one another and to the channel member 120 with the bolt, for instance, extending through the aperture 414a, through one of the apertures 158b, 158c, 158d, 158e, 158f, and through the aperture 414b.

The prong portions 394a, 394b are configured to be inserted into the apertures 372, 374 of the dual catch cup 354 in order to lock the dual catch cup 354 to each of the support members 356a, 356b. The prong members 420a, 422a; 420b, 422b are configured to be flexed inwardly when being inserted into the apertures 372, 374, but to flex outwardly once the ledges 424a, 426a; 424b, 426b protrude beyond the bottom surface 370 of the middle member 358 of the dual catch cup 354, such that the prong portions 394a, 394b lock in place within the apertures 372, 374. The support members 356a, 356b can be removed from locking engagement with the dual catch cup 354, if desired, by flexing the prong members 420a, 422a; 420b, 422b inwardly such that they can move back through the apertures 372, 374.

As illustrated in FIG. 22, the fourth and fifth leg members 134, 136 of the channel member 120 are configured to sit on the cut-outs 420a, 420b of the support members 356a, 356b in order to help prevent the catch cup assembly 352 from pulling up or moving up under force as the channel member 120 holds the support members 356a, 356b, and thus the entire catch cup assembly 352 down.

The channel member 120 is provided with five different apertures 158b, 158c, 158d, 158e, 158f to allow for different connection configurations of the catch cup assemblies 352 thereto. In one preferred embodiment, only a single catch cup assembly 352 is secured to the channel member 120 through aperture 158d. In another preferred embodiment, two catch cup assemblies 352 are secured to the channel member 120 through apertures 158c, 158e. In another preferred embodiment, three catch cup assemblies 352 are secured to the channel member 120 through apertures 158b, 158d, 158f. It is to be understood that other configuration of the catch cup assemblies 352, or more than three catch cup assemblies 352 could be provided, if desired. Two nipple assemblies 318 are provided for each catch cup assembly 352 provided, as generally illustrated in FIGS. 1 and 26, and are preferably spaced from one another by approximately seven (7) inches. While possible to include more catch cup assemblies 352 and nipple assemblies 318, it is not preferred in order to ensure that the birds have adequate room between each catch cup assembly 352 and nipple assembly 318 to drink therefrom. If the catch cup assemblies 352 and nipple assemblies 318 are provided too close to one another, the birds may elect to not drink therefrom. It is also an advantage of this watering system 100 that two nipple assemblies 318 and one catch cup assembly 352 are separated from adjacent nipple assemblies 318 and catch cup assemblies 352 in order to provide distinct and separable drinking points (or points of interest) for the birds to flock to.

Thus, the watering system 100 provides a number of advantages, some of which have already been discussed hereinabove. The watering system 100 improves sanitation by providing cleaner water and allowing for less virus/disease transmission. The watering system 100 provides for improved environmental conditions by reducing water spillage, reducing waste of water, providing dryer litter conditions, and decreasing ammonia volatilization. The watering system 100 eliminates or reduces labor by not requiring that the waterers, such as prior art bell waterers, be cleaned or moved daily, and by eliminating or significantly reducing the need to till litter. The watering system 100 reduces plant condemnation by providing for healthier birds and reducing the amount of feet problems.

The watering system 100 also provides a substantial labor savings as the watering systems 100 will not need to be moved as often as prior art watering systems, the drinker cups do not need to be cleaned and disinfected as often as would prior art bell drinkers, and tilling could be done less. All of this adds up to a substantial savings per flock of poultry.

Experimental testing of the watering systems 100 has shown that the watering systems 100 are durable enough to handle the abuse inflicted on them by turkeys, and has further shown that the weight of the turkeys is better than or equal to prior art watering systems for turkeys, and that the mortality of the turkeys was reduced compared to prior art watering systems.

While a preferred embodiment of the invention is shown and described, it is envisioned that those skilled in the art may devise various modifications without departing from the spirit and scope of the foregoing description and the appended claims.

The invention is claimed as follows:

1. A watering system for providing water to birds comprising:
an elongated channel assembly;
an elongated pipe assembly for receiving the water, said elongated pipe assembly being at least partially covered and supported by said elongated channel assembly;
first and second spaced apart nipple assemblies connected to said elongated pipe assembly, each said nipple assembly configured to provide the birds with access to the water within said elongated pipe assembly when the birds trigger said nipple assemblies; and
a catch cup assembly secured to said elongated channel assembly, said catch cup assembly having a first catch basin which is positioned below said first nipple assembly in order to catch water from said first nipple assembly when the birds trigger said first nipple assembly, said catch cup assembly further having a second catch basin which is positioned below said second nipple assembly in order to catch water from said second nipple assembly when the birds trigger said second nipple assembly.

2. The watering system as defined in claim 1, wherein said elongated pipe assembly includes first and second pipe members having first and second ends and a pipe coupling assembly, said pipe coupling assembly configured to receive and seal therein in a water-tight manner said second end of said first pipe member and said first end of said second pipe member.

3. The watering system as defined in claim 2, wherein said elongated channel assembly having first, second and third leg members connected to one another at a junction such that said elongated channel assembly is generally Y-shaped in configuration, said elongated channel assembly having first and second flange members extending therefrom, said first flange member extending from said second leg member generally toward said third leg member and defining a first slot provided between said second leg member and said first flange member, said second flange member extending from said third leg member generally toward said second leg member and defining a second slot provided between said third leg member and said second flange member.

4. The watering system as defined in claim 3, wherein said pipe coupling assembly has first and second extensions, said first extension configured to be inserted into said first slot of said elongated channel assembly and said second extension configured to be inserted into said second slot of said elongated channel assembly such that said elongated channel assembly at least partially supports said elongated pipe assembly.

5. The watering system as defined in claim 3, wherein each of said nipple assemblies has a valve saddle which is secured to said elongated pipe assembly, said valve saddle having first and second extensions, said first extension configured to be inserted into said first slot of said elongated channel assembly and said second extension configured to be inserted into said second slot of said elongated channel assembly such that said elongated channel assembly at least partially supports said elongated pipe assembly.

6. The watering system as defined in claim 1, wherein said first and second catch basins are generally oval-shaped in configuration.

7. The watering system as defined in claim 1, wherein said first and second catch basins have bottoms which have at least one raised portion.

8. The watering system as defined in claim 1, wherein each said nipple assembly includes a generally spherical contact ball having an aperture extending therethrough from a generally flat top thereof to a generally flat bottom thereof and a valve pin extending downwardly from said elongated pipe assembly and into at least a portion of said aperture, said contact ball and said valve pin configured to be triggered by the birds in order to provide them with water from the elongated pipe assembly.

9. The watering system as defined in claim 1, further including at least one hangar having a bottom member and first and second extension members extending from opposite ends of said bottom member, said bottom member is wrapped around at least a portion of said elongated channel assembly and at least a portion of said elongated pipe assembly, said first and second extension members being configured to be secured to one another above said elongated channel assembly and to be secured to a cable assembly such that said watering system can be raised or lowered via said cable assembly.

10. The watering system as defined in claim 9, wherein said first and second extension members are further configured to be secured to one another around a previously installed anti-roost wire provided above said elongated channel assembly, said hangar defining a boundary for unimpeded movement of said anti-roost wire.

11. The watering system as defined in claim 1, wherein said catch cup assembly further includes first and second support members and a middle member, said middle member being provided between, and connected to, each of said first and second catch basins, said first support member being secured to a first side of said elongated channel assembly and to said middle member proximate to a first end thereof, said second support member being secured to a second side of said elongated channel assembly and to said middle member proximate to a second end thereof.

12. The watering system as defined in claim 11, wherein said first support member has at least one flange member which extends inwardly therefrom upon which a first portion of said elongated channel assembly is positioned, and wherein said second support member has at least one flange member which extends inwardly therefrom upon which a second portion of said elongated channel assembly is positioned.

13. A watering system for providing water to birds comprising:
an elongated channel assembly;
an elongated pipe assembly for receiving the water, said elongated pipe assembly being at least partially covered and supported by said elongated channel assembly; and
at least one hangar having a bottom member and first and second extension members extending from opposite ends of said bottom member, said bottom member being wrapped around at least a portion of said elongated channel assembly and at least a portion of said elongated pipe assembly, said first and second extension members being configured to be secured to one another above said elongated channel assembly and to be secured to a cable assembly such that said watering system can be raised or lowered via said cable assembly.

14. The watering system as defined in claim 13, wherein said first and second extension members are further configured to be secured to one another around a previously installed anti-roost wire provided above said elongated channel assembly, said hangar defining a boundary for unimpeded movement of said anti-roost wire.

15. The watering system as defined in claim 13, further comprising first and second spaced apart nipple assemblies connected to said elongated pipe assembly, each said nipple assembly configured to provide the birds with access to the water within said elongated pipe assembly when the birds trigger said nipple assemblies.

16. The watering system as defined in claim 15, further comprising a catch cup assembly secured to said elongated channel assembly, said catch cup assembly having a first catch basin which is positioned below said first nipple assembly in order to catch water from said first nipple assembly when the birds trigger said first nipple assembly, said catch cup assembly further having a second catch basin which is positioned below said second nipple assembly in order to catch water from said second nipple assembly when the birds trigger said second nipple assembly.

17. The watering system as defined in claim 16, wherein said first and second catch basins are generally oval-shaped in configuration.

18. The watering system as defined in claim 16, wherein said first and second catch basins have bottoms which have at least one raised portion.

19. The watering system as defined in claim 15, wherein each said nipple assembly includes a generally spherical contact ball having an aperture extending therethrough from a generally flat top thereof to a generally flat bottom thereof and a valve pin extending downwardly from said elongated pipe assembly and into at least a portion of said aperture, said contact ball and said valve pin configured to be triggered by the birds in order to provide them with water from the elongated pipe assembly.

20. A watering system for providing water to birds comprising:
an elongated channel assembly;
an elongated pipe assembly for receiving the water, said elongated pipe assembly being at least partially covered and supported by said elongated channel assembly;
at least one hangar having a bottom member and first and second extension members extending from opposite ends of said bottom member, said bottom member being wrapped around at least a portion of said elongated channel assembly and at least a portion of said elongated pipe assembly, said first and second extension members being configured to be secured to one another above said elongated channel assembly and to be secured to a cable assembly such that said watering system can be raised or lowered via said cable assembly;
first and second spaced apart nipple assemblies connected to said elongated pipe assembly, each said nipple assembly configured to provide the birds with access to the water within said elongated pipe assembly when the birds trigger said nipple assemblies; and
a catch cup assembly secured to said elongated channel assembly, said catch cup assembly having a first catch basin which is positioned below said first nipple assembly in order to catch water from said first nipple assembly when the birds trigger said first nipple assembly, said catch cup assembly further having a second catch basin which is positioned below said second nipple assembly in order to catch water from said second nipple assembly when the birds trigger said second nipple assembly.
